(19) United States
(12) Patent Application Publication
(10) Pub. No.: US 2024/0198549 A1
(43) Pub. Date: Jun. 20, 2024

(54) SHAVING DEVICE

(71) Applicant: BIC Violex Single Member S.A., Anoixi (GR)

(72) Inventors: Panagiotis KOPELAS, Anoixi (GR); Christos KEROSIS, Anoixi (GR)

(73) Assignee: BIC Violex Single Member S.A., Anoixi (GR)

(21) Appl. No.: 18/540,240

(22) Filed: Dec. 14, 2023

(30) Foreign Application Priority Data
Dec. 14, 2022 (EP) 22213536.0

(51) Int. Cl. B26B 21/52

(52) U.S. Cl. CPC B26B 21/521

(57) ABSTRACT

A pivot mechanism including a first pivot member including a support extending along an axis between a first end and a second end, a first pivot element, and a second pivot element, a second pivot member configured to interact with the first pivot member, at least a portion of the second pivot member being configured to apply a force on the first pivot element and the second pivot element, wherein the first pivot element and the second pivot element are configured to receive a force applied by the second pivot member and each of the first pivot element and the second pivot element are configured to flex in response to receiving the force applied by the second pivot member.

### CROSS-REFERENCE TO RELATED APPLICATIONS

This application claims benefit from European patent application EP 22213536.0 filed on 14 Dec. 2022, its content being incorporated herein by reference.

### FIELD

The present disclosure relates generally to the field of skincare, and in particular to shaving. More specifically, the present disclosure relates to a pivot mechanism configured for use on a shaving device.

### BACKGROUND

A typical handheld shaving device includes a handle and a replaceable shaving cartridge that is, and/or is configured to be, connected to the handle. Additionally, the shaving cartridge of the typical shaving device may be configured to pivot with respect to the handle of the shaving device.

In the typical shaving device having a pivoting shaving cartridge, a pivot mechanism of the shaving device usually includes an assembly of numerous complex components, causing the pivot mechanism and, thus, the shaving device, to have increased modes of failure, increased costs of manufacture, and/or complicated functionality. Additionally, in currently available versions of the typical shaving device having a pivoting shaving cartridge that attempt to reduce the number of complex components, the resulting pivot mechanism of the shaving device is usually fragile and/or increasingly predisposed to breakage, causing the pivot mechanism and, thus, the shaving device, to be less durable.

It is desirable to provide a pivot mechanism for a shaving device that is configured so as to reduce and/or simplify components of the pivot mechanism and, thus, the shaving device, while also improving durability of the pivot mechanism and, thus, the shaving device.

### SUMMARY

According to a first aspect of the disclosure, a pivot mechanism configured for use on a shaving device is provided. The pivot mechanism includes a first pivot member including a support extending along an axis between a first end and a second end, a first pivot element, at least a portion of which extends axially from the first end of the support toward the second end of the support, and a second pivot element, at least a portion of which extends axially from the first end of the support toward the second end of the support, a second pivot member configured to interact with the first pivot member, at least a portion of the second pivot member being configured to apply a force on the first pivot element and the second pivot element, wherein the first pivot element and the second pivot element are configured to receive a force applied by the second pivot member and each of the first pivot element and the second pivot element are configured to flex in response to receiving a force applied by the second pivot member.

According to aspects of the disclosure, the first pivot element and the second pivot element may be elastically deformable.

According to aspects of the disclosure, the first pivot element and the second pivot element may be aligned with each other along the axis.

According to aspects of the disclosure, a gap may be defined between at least a portion of the first pivot element and the second pivot element.

According to aspects of the disclosure, the first pivot element may have a first length and the second pivot element may have a second length, and the first length of the first pivot element may be greater than the second length of the second pivot element.

According to aspects of the disclosure, the first pivot element may extend to a position beyond the second end of the support.

According to aspects of the disclosure, the support may define a cavity extending between the first end and the second end of the support.

According to aspects of the disclosure, at least a portion of one or more of the first pivot element and the second pivot element may extend within the cavity of the support.

According to aspects of the disclosure, the cavity of the support may extend to an opening at the second end of the support.

According to aspects of the disclosure, the first pivot element may include an arcuate portion.

According to aspects of the disclosure, at least a portion of the first pivot element may extend within a first plane along the axis, at least a portion of the second pivot element may extend within a second plane along the axis, and at least a portion of the first pivot element may extend toward the second plane corresponding to second pivot element.

According to aspects of the disclosure, the support, the first pivot element, and the second pivot element may be integrally formed in one piece.

According to a second aspect of the disclosure, a shaving device is provided. The shaving device includes a shaving head configured to support one or more blade, a handle configured to be held by a user, and the pivot mechanism according to any aspect of the disclosure presented herein.

According to aspects of the disclosure, the first pivot member of the pivot mechanism may be included on the handle of the shaving device and the second pivot member of the pivot mechanism may be included on the shaving head of the shaving device.

According to aspects of the disclosure, the first pivot member of the pivot mechanism and the handle of the shaving device may be integrally formed in one piece.

In the manner described and according to aspects illustrated herein, the pivot mechanism and/or the shaving device are configured to reduce and/or simplify components of the pivot mechanism and/or the shaving device, while also improving durability of the pivot mechanism and/or the shaving device.

### BRIEF DESCRIPTION OF THE DRAWINGS

Aspects of an embodiment will be described in reference to the drawings, where like numerals reflect like elements:

FIG. 1 is a top perspective view of a pivot mechanism included on a shaving device according to aspects of the disclosure;

FIG. 2 is an enlarged top perspective view of the pivot mechanism included on the shaving device according to FIG. 1;

FIG. 3 is a side cross-sectional view of the pivot mechanism according to FIG. 1, taken along an axis A-A of the pivot mechanism;

FIG. 4 is a top exploded view of the pivot mechanism according to FIG. 1;

FIG. 5 is a front perspective view of a first pivot member of the pivot mechanism according FIG. 1;

FIG. 6 is a top perspective view of the first pivot member of the pivot mechanism according to FIG. 1;

FIG. 7 is a bottom perspective view of the first pivot member of the pivot mechanism according to FIG. 1; and

FIG. 8 is a side cross-sectional view of the first pivot member of the pivot mechanism according to FIG. 1, taken along the axis A-A of the pivot mechanism.

### DETAILED DESCRIPTION

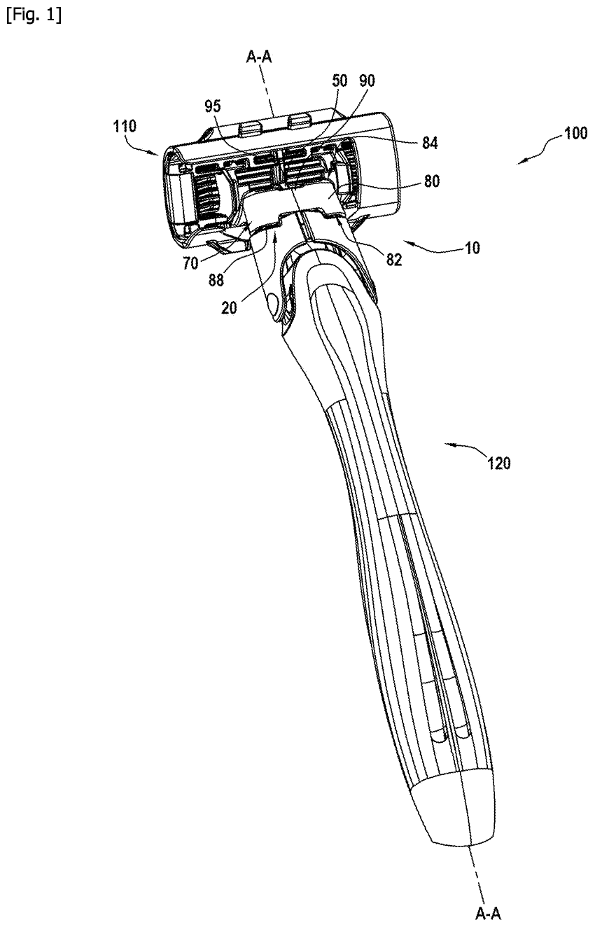

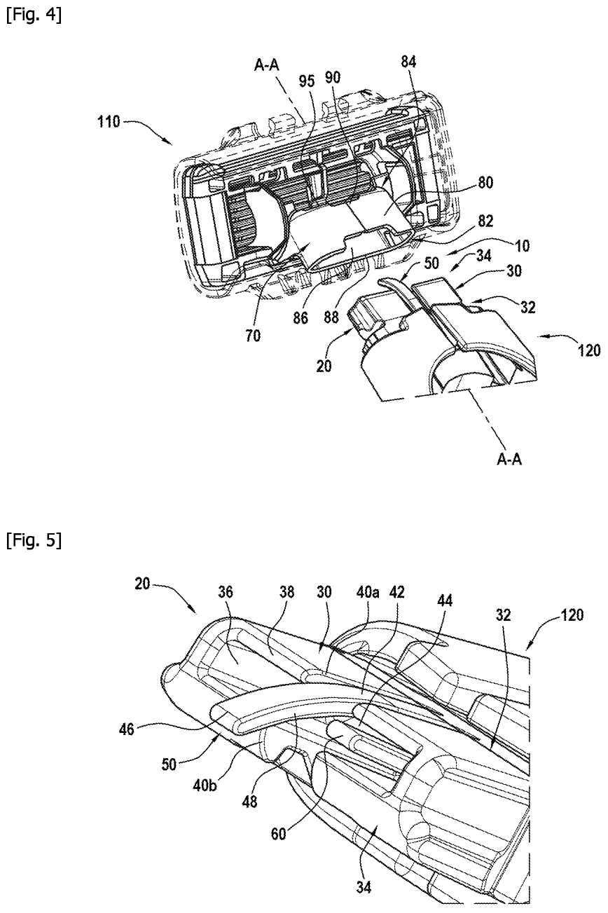

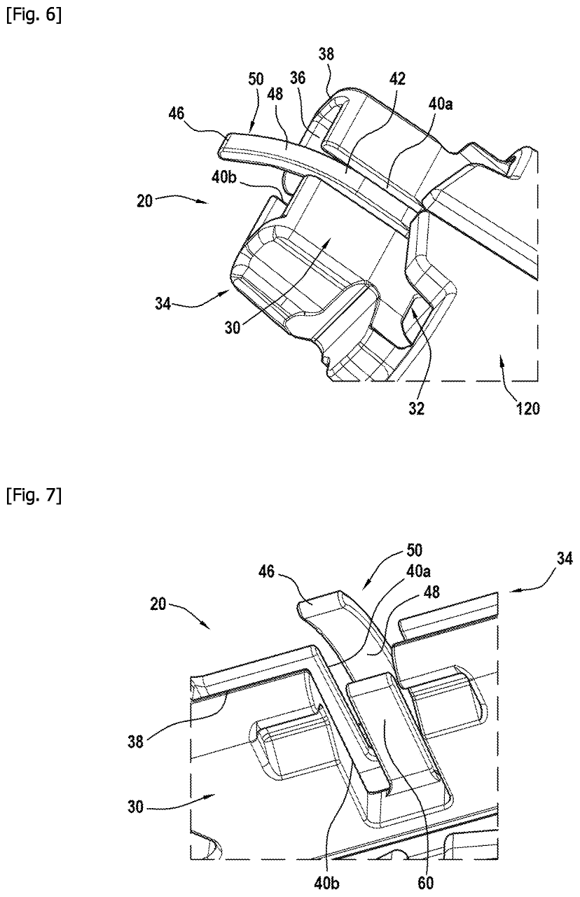

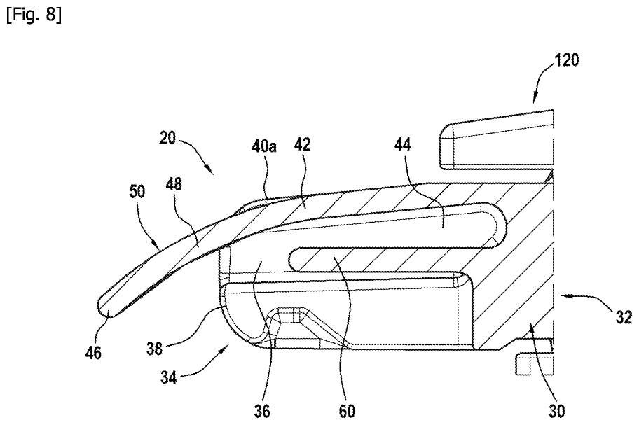

A pivot mechanism configured for use on a shaving device according to aspects of the disclosure will now be described with reference to FIGS. 1-8, wherein like numerals represent like parts, and will generally be referred to by the reference numeral 10. Although the pivot mechanism 10 is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its sense including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

As shown in FIGS. 1-3, the pivot mechanism 10 is configured to simplify and/or reduce components employed by a shaving device 100. In examples, the shaving device 100 includes a head (also referred to herein as a “shaving cartridge”) 110 and a handle 120. In examples, the pivot mechanism 10 is also configured to allow the head 110 of the shaving device 100 to pivot with respect to the handle 120 of the shaving device 100, while controlling a pivot angle of the head 110 with respect to the handle 120, so as to allow the head 110 to move more freely and smoothly along contours of a surface being shaved, resulting in a closer, more ergonomic shaving experience for the user.

It is contemplated that the head 110 of the shaving device 100 is configured for shaving a body part (e.g. a face, arm, leg, and/or the like) of a user. Accordingly, the head 110 may include one or more blades manufactured from sheet metal and/or the like extending across the head 110. Additionally, it is contemplated that the handle 120 of the shaving device 100 is configured to be held by a hand of the user. Accordingly, the handle 120 may include an elongated, ergonomic shape corresponding to the hand of the user. Additionally, it is contemplated that the head 110 may be connected, coupled, and/or configured to be coupled to the handle 120. To this end, it is contemplated that the head 110 and the handle 120 may be connected and/or coupled by any type of connection, construction, and/or coupling mechanism that may be compatible with the pivot mechanism 10 and/or the shaving device 100. Additionally or alternatively, it is contemplated that aspects of the pivot mechanism 10 (i.e. a first pivot member 20 and a second pivot member 70 of the pivot mechanism 10—discussed further below) may function as a coupling mechanism between the head 110 and the handle 120. Further, it is contemplated that aspects of the pivot mechanism 10 may be included on and/or form part of the head 110 and/or the handle 120 (discussed further below). Accordingly, the pivot mechanism 10 may be considered to be part of the shaving device 100.

As shown in FIGS. 1-2 and 4, the pivot mechanism 10 extends along an axis A-A. Additionally or alternatively, the pivot mechanism 10 is bisected by the axis A-A. In examples, the pivot mechanism 10 includes a first pivot member 20 that may include a support 30, a first pivot element 50, and a second pivot element 60; and a second pivot member 70 that may include an adaptor 80 and a pivot base 95. The first pivot member 20 and the second pivot member 70 each extend along the axis A-A. Additionally or alternatively, the first pivot member 20 and the second pivot member 70 are each bisected by the axis A-A. As discussed herein, the first pivot member 20 and the second pivot member 70 of the pivot mechanism 10 and/or the shaving device 100 are configured to reduce and simplify components of the pivot mechanism 10 and/or the shaving device 100, while also improving durability of the pivot mechanism 10 and/or the shaving device 100.

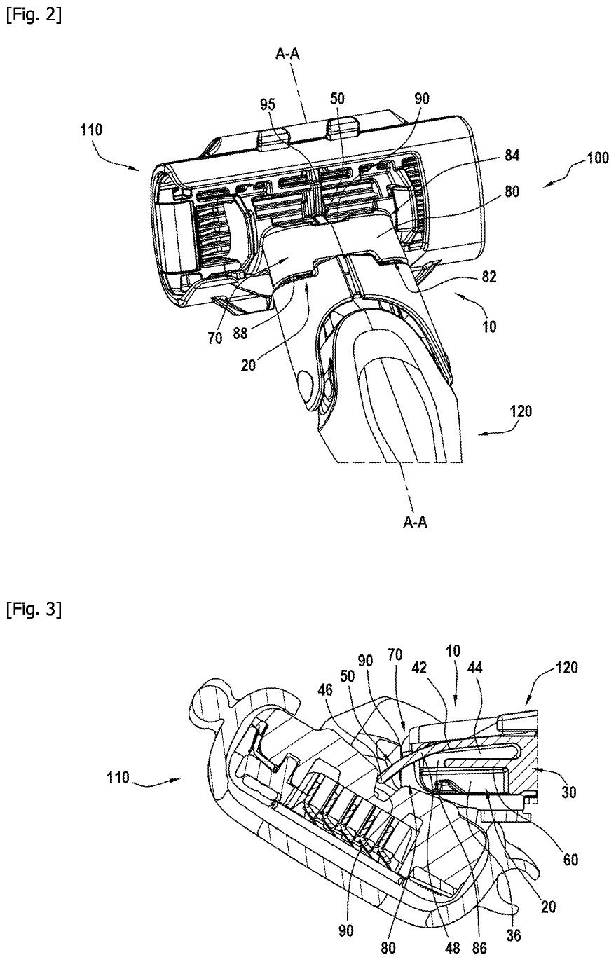

As shown by FIGS. 2-8, the first pivot member 20 of the pivot mechanism 10 (i.e. the support 30 of the first pivot member 20, the first pivot element 50 of the first pivot member 20, and the second pivot element 60 of the first pivot member 20) may be included on the handle 120 of the shaving device 100. As such, it is contemplated that the first pivot member 20 may be considered to be part of the handle 120. Additionally or alternatively, the first pivot member 20 may be integrally formed in one piece. Additionally or alternatively, the first pivot member 20 and the handle 120 may be integrally formed in one piece. In this manner, by including the first pivot member 20 on the handle 120 and/or forming the first pivot member 20 and the handle 120 integrally in one piece, the handle 120 may be saved and reused by the user with a replacement and/or alternative head 110 of the shaving device 100, thereby extending the life of the handle 120 of the shaving device 100. Additionally, in this manner, the first pivot member 20 may be constructed along with the handle 120, so as to minimize complexity and, thus, cost of manufacture of the pivot mechanism 10 and/or the shaving device 100. In examples, the first pivot member 20 may be constructed along with the handle 120, through construction processes such as additive manufacturing and/or 3D printing, thereby further minimizing complexity and, thus, cost of manufacture of the pivot mechanism 10 and/or the shaving device 100.

It is contemplated that construction processes such as additive manufacturing and/or 3D printing also allows for usage of materials for construction of the pivot mechanism 10 and/or the shaving device 100 that allow for increased durability of the pivot mechanism 10 and/or the shaving device 100—such as, for rigid aspects of one or more component of the first pivot member 20 of the pivot mechanism 10 (i.e. one or more of the support 30 of the first pivot member 20, the first pivot element 50 of the first pivot member 20, the second pivot element 60 of the first pivot member 20), the second pivot member 70 of the pivot mechanism 10 (i.e. one or more of the adaptor 80 of the second pivot member 70 and the pivot base 95 of the second pivot member 70), and the handle 120 of the shaving device 100, usage of acrylonitrile butadiene styrene (ABS)-like photopolymer resin and polypropylene-like photopolymer resin. It is contemplated that an example of ABS-like photopolymer resin may include usage of Digital ABS™, produced by Stratasys™, and that an example of usage of polypropylene-like photopolymer resin may include usage of Durus™ and/or Rigur™, also produced by Stratasys™. Additionally or alternatively, it is contemplated that construction processes such as additive manufacturing and/or 3D printing also allows for usage of materials for construction of the pivot mechanism 10 and/or the shaving device 100 that allow for increased durability of the pivot mechanism 10 and/or the shaving device 100—such as, for flexible features of one or more component of the first pivot member 20 of the pivot mechanism 10 (i.e. one or more of the support 30 of the first pivot member 20, the first pivot element 50 of the first pivot member 20, the second pivot element 60 of the first pivot member 20), the second pivot member 70 of the pivot mechanism 10 (i.e. one or more of the adaptor 80 of the second pivot member 70 and the pivot base 95 of the second pivot member 70), and the handle 120 of the shaving device 100, usage of rubber-like photopolymer resin. It is contemplated that an example of usage of rubber-like photopolymer resin may include usage of a material having a Shore durometer (hardness) within a range of 40-85 and, in particular, a Shore durometer of 60. Additionally or alternatively, it is contemplated that an example of usage of rubber-like photopolymer resin may include usage of Tango™ and/or Agilus30™ produced by Stratasys™.

As shown by FIGS. 2-8, the support 30 and, thus, the first pivot member 20 of the pivot mechanism 10, is included on and/or extends from a position on the handle 120 of the shaving device 100 that is at or adjacent to a portion of the handle 120 that is configured to couple with the head 110 of the shaving device 100, so as to allow the head 110 to pivot with respect to the handle 120. The adaptor 80 and, thus, the second pivot member 70 of the pivot mechanism 10, is included on and/or extends from a position on the head 110 that is at or adjacent to a portion of the head 110 that is configured to couple with the handle 120 (discussed further below).

Referring to FIGS. 2-4, the support 30 of the first pivot member 50 may be configured to be received by and/or engaged with the head 110 of the shaving device 100. In particular, the support 30 may be configured to be received by and/or engaged with the adaptor 80 of the second pivot member 70. It is contemplated that the support 30 may be received by and/or engaged with the adaptor 80 by way of a an interference-fit engagement with the adaptor 80 so as to allow for ease of engagement and disengagement between the support 30 and the adaptor 80; however, it is contemplated that other engagements between the support 30 and the adaptor 80 may be compatible with the pivot mechanism 10. To this end, the support 30 may be contoured to be received by and/or engaged with the adaptor 80 and, thus, the head 110. It is contemplated that the engagement between the support 30 and the adaptor 80 may function as a coupling mechanism between the head 110 and the handle 120 of the shaving device 100.

Referring to FIGS. 5-8, the support 30 extends axially between a first end 32 and a second end 34. In examples, during coupling of the head 110 of the shaving device 100 with the handle 120 of the shaving device 100, the second end 34 of the support 30 is received by the adaptor 80 of the second pivot member 70 before the first end 32 of the support 30 is positioned adjacent the adaptor 80 and/or received by the adaptor 80. As such, it is contemplated that the second end 34 of the support 30 may be considered and/or referred to as a “butt end” of the support 30 and, thus, the handle 120. In examples, the support 30 defines a cavity 36 extending axially between the first end 32 and the second end 34 of the support 30. In examples, the cavity 36 extends from the first end 32 of the support 30 to and/or through the second end 34 of the support 30. The cavity 36 is configured to surround and/or house at least a portion of the first pivot element 50 and the second pivot element 60 of the first pivot member 50. It is contemplated that the cavity 36 is configured to provide space for flexure of the first pivot element 50 and the second pivot element 60, in directions corresponding to a force applied to the head 110 during shaving, thereby allowing for pivoting of the head 110 with respect to the handle 120 (discussed further below). Further, the cavity 36 is in communication with an opening 38 defined at the second end 34 of the support 30, such that at least a portion of one or more of the first pivot element 50 and the second pivot element 60 may extend out of the second end 34 of the support 30 and/or such that the first pivot element 50 and the second pivot element 60 are capable of interacting with the adaptor 80 (discussed further below).

In examples, the support 30 may define one or more clearance 40a, 40b extending axially between the first end 32 and the second end 34 of the support 30 of the first pivot member 20. In examples, the one or more clearance 40a, 40b is configured to align with one or more of the first pivot element 50 and the second pivot element 60 of the first pivot member 20, in a plane that is perpendicular or substantially perpendicular to one or more of the first pivot element 50 and the second pivot element 60, so as to provide additional space for flexure of one or more of the first pivot element 50 and the second pivot element 60 in the plane that is perpendicular or substantially perpendicular to one or more of the first pivot element 50 and the second pivot element 60. In examples, the support 30 may define a first clearance 40a corresponding to the first pivot element 50 and a second clearance 40b corresponding to the second pivot element 60. In examples, the support 30 may have a tubular shape. In this manner, the first pivot element 50 and the second pivot element 60 may be positioned to interact with the adaptor 80 of the second pivot member 70, so as to allow the head 110 of the shaving device 100 to pivot with respect to the handle 120 of the shaving device 100, while also protecting the first pivot element 50 and the second pivot element 60 from an environment external to the shaving device 100.

As illustrated by FIGS. 3 and 5-8, the first pivot element 50 and the second pivot element 60 of the first pivot member 20 are configured to interact with the head 110 of the shaving device 100 to allow the head 110 to pivot with respect to the handle 120 of the shaving device 100. In particular, the first pivot element 50 and the second pivot element 60 are configured to interact with the second pivot member 70 to allow the head 110 to pivot with respect to the handle 120. More in particular, the first pivot element 50 is configured to interact directly with the second pivot member 70 (i.e. the pivot base 95 of the second pivot member 70—discussed further below), being configured to directly engage with the second pivot member 70, and the second pivot element 60 is configured to interact indirectly with the second pivot member 70, being configured to directly engage with the first pivot element 50 to share a load distribution between the first pivot element 50 and the second pivot element 60 when a force is exerted on the first pivot element 50 by the second pivot member 70. Additionally or alternatively, the first pivot element 50 and the second pivot element 60 are configured to provide a return spring force on the second pivot member 70 (i.e. the pivot base 95 of the second pivot member 70—discussed further below), thereby biasing the head 110 toward a rest position from a pivoted position. To this end, the first pivot element 50 and the second pivot element 60 are configured to flex and/or be elastically deformable. In this manner, the first pivot element 50 and the second pivot element 60 are configured to receive a force exerted on the first pivot element 50 and the second pivot element 60 by the second pivot member 70. Additionally, in this manner, the first pivot element 50 and the second pivot element 60 are configured for flexure in response to a force exerted on the first pivot element 50 and the second pivot element 60 by the second pivot member 70. As such, the first pivot element 50 and the second pivot element 60 are configured to return a force to the second pivot member 70, thereby sharing a load distribution corresponding to force exerted by the second pivot member 70 between the first pivot element 50 and the second pivot element 60 and controlling a pivot angle of the head 110 when a force is exerted on the first pivot element 50 by the second pivot member 70.

Referring to FIGS. 3 and 5-8, the first pivot element 50 and the second pivot element 60 of the first pivot member 20 each extend from the support 30 of the first pivot member 20, in the form of a projection and/or tongue-shaped body. In particular, at least a portion of the first pivot element 50 and the second pivot element 60 each extend from the first end 32 of the support 30 toward the second end 34 of the support 30. In this manner, at least a portion of the first pivot element 50 and the second pivot element 60 each extend from the first end 32 of the support 30, through the cavity 36 defined by the support 30, toward the second end 34 of the support 30. In examples, the first pivot element 50 has a first length, the second pivot element 60 has a second length, and the first length of the first pivot element 50 is greater than the second length of the second pivot element 60. At least a portion of one or more of the first pivot element 50 and the second element may extend out of the opening 38 defined at the second end 34 of the support 30, to a position beyond the second end 34 of the support 30. In examples, at least a portion of the first pivot element 50 extends out of the opening 38 defined at the second end 34 of the support 30, beyond the second end 34 of the support 30, and the second pivot element 60 extends to a position at or adjacent to the second end 34 of the support 30. In examples, the second pivot element 60 extends to a position corresponding to a central portion 42 of the first pivot element 50, so as to be positioned to adequately share a load distribution between the first pivot element 50 and the second pivot element 60 when a force is exerted on the first pivot element 50 by the second pivot member 70.

Referring to FIGS. 3 and 5-8, at least a portion of the first pivot element 50 of the first pivot member 20 extends within a first plane along the axis A-A and at least a portion of the second pivot element 60 of the first pivot member 20 extends within a second plane along the axis A-A. In examples, the first pivot element 50 and the second pivot element 60 are aligned with each other along the axis A-A. As such, a gap 44 is defined between at least a portion of the first pivot element 50 and the second pivot element 60. In examples, at least a portion of the first pivot element 50 extends toward the second plane corresponding to second pivot element 60. As such, the first pivot element 50 may include an arcuate portion 48, at least a portion of which curves towards the second plane corresponding to the second pivot element 60. In examples, the arcuate portion 48 of the first pivot element 50 curves through the second plane corresponding to the second pivot element 60, to a position beyond the second plane corresponding to the second pivot element 60. In this manner, when the first pivot member 20 is engaged with the second pivot member 70, the first pivot element 50 is configured to engage with the second pivot member 70 to receive a force exerted on the first pivot element 50 by the second pivot member 70 during a shaving action. Additionally, the first pivot element 50 is configured to flex into the gap 44 between the first pivot element 50 and the second pivot element 60, allowing the head 110 of the shaving device 100 to pivot with respect to the handle 120 of the shaving device 100, and also engaging with the second pivot element 60 at the central portion 42 of the first pivot element 50. In this manner, the first pivot element 50 and the second pivot element 60 are configured to share a load distribution corresponding to force exerted by the second pivot member 70 between the first pivot element 50 and the second pivot element 60 and control a pivot angle of the head 110 of the shaving device 100 when a force is exerted on the first pivot element 50 by the second pivot member 70, thereby improving durability of the pivot mechanism 10 and/or the shaving device 100 with a simplified configuration.

As shown by FIGS. 2-4, the second pivot member 70 of the pivot mechanism 10 (i.e. the adaptor 80 of the second pivot member 70 and the pivot base 95 of the second pivot member 70) may be included on the head 110 of the shaving device 100. As such, it is contemplated that the second pivot member 70 may be considered to be part of the head 110. In examples, the adaptor 80 and, thus, the second pivot member 70, is included on and/or extends from a position on the head 110 that is at or adjacent to a portion of the head 110 that is configured to couple with the handle 120 of the shaving device 100. In examples, the adaptor 80 may be configured to receive and/or engage with the handle 120. In particular, the adaptor 80 may be configured to receive and/or engage with the support 30 of the first pivot member 20. It is contemplated that the adaptor 80 may receive and/or engage with the support 30 by way of an interference-fit engagement with the support 30 so as to allow for ease of engagement and disengagement between the adaptor 80 and the support 30; however, it is contemplated that other engagements between the adaptor 80 and the support 30 may be compatible with the pivot mechanism 10. To this end, the adaptor 80 may be contoured to receive and/or engage with the support 30 and, thus, the handle 120 of the shaving device 100. As discussed above, it is contemplated that the engagement between the adaptor 80 and the support 30 may function as a coupling mechanism between the head 110 and the handle 120.

Referring to FIGS. 2-4, the adaptor 80 extends axially between a first end 82 and a second end 84. In examples, during coupling of the head 110 of the shaving device 100 with the handle 120 of the shaving device 100, the second end 34 of the support 30 of first pivot member 20 is received through the first end 82 of the adaptor 80. To this end, the adaptor 80 defines a chamber 86 extending axially between the first end 82 and the second end 84 of the adaptor 80. In examples, the chamber 86 extends from and/or through the first end 82 of the adaptor 80 to and/or through the second end 84 of the adaptor 80. The chamber 86 is configured to surround at least a portion of one or more of the support 30, the first pivot element 50, and the second pivot element 60, so that the adaptor 80 may engage the support 30 and/or so that the first pivot element 50 may engage the second pivot member 70 (i.e. the pivot base 95 of the second pivot member 70—discussed further below). The chamber 86 is in communication with a first opening 88 defined at the first end 82. Additionally or alternatively, the chamber 86 may be in communication with the first opening 88 defined at the first end 82 of the adaptor 80 and a second opening 90 defined at the second end 84 of the support 30. In this manner, at least a portion of one or more of the support 30, the first pivot element 50, and the second pivot element 60 may be received within the chamber 86 through the first opening 88 at first end 82 of the adaptor 80, thereby allowing the adaptor 80 to engage the support 30 and the first pivot element 50 to engage the second pivot member 70 (i.e. the pivot base 95 of the second pivot member 70—discussed further below).

It is contemplated that the second pivot member 70 may not include the adaptor 80. In examples, one or more of the first pivot member 20 and the second pivot member 70 may include one or more arm (also referred to herein as “bearings”) (not shown). In examples, the one or more arm may extend from the handle 120 of the shaving device 100. Additionally, in examples, the one or more arm and the handle 120 may be integrally formed in one piece, at the portion of the handle 120 that is configured to couple with the head 110 of the shaving device 100. As such, the one or more arm may be configured to interact with the head 110, such that the head 110 and the handle 120 may couple with each other and/or otherwise engage each other, in a manner in which the head 110 is capable of pivoting with respect to the handle 120. In examples, the one or more arm may be arcuate in shape.

As illustrated by FIGS. 2-4, the second pivot member 70 is configured to interact with the first pivot member 20 to allow the head 110 of the shaving device 100 to pivot with respect to the handle 120 of the shaving device 100. To this end, the second pivot member 70 includes the pivot base 95, which is configured to interact with the first pivot element 50 and the second pivot element 60 of the first pivot member 20 to allow the head 110 to pivot with respect to the handle 120. In particular, the pivot base 95 is configured to interact directly with the first pivot element 50, being configured to directly engage with and/or apply a force on the first pivot element 50, and to interact indirectly with the second pivot element 60, which directly engages the first pivot element 50 to share a load distribution between the first pivot element 50 and the second pivot element 60 when a force is applied on the first pivot element 50 by the pivot base 95.

In examples, the pivot base 95 of the second pivot member 70 is included at a position at or adjacent to the second end 84 of the adaptor 80 of the second pivot member 70. Additionally or alternatively, the pivot base 95 of the second pivot member 70 may be included at or adjacent to the second opening 90 at the second end 84 of the adaptor 80. Additionally or alternatively, the pivot base 95 may be included on and/or form part of the head 110 of the shaving device 100. In this manner, when the support 30 of the first pivot member 20 is engaged with the adaptor 80, the first pivot element 50 extends through the chamber 86 of the adaptor 80, to and/or through the second end 84 of the adaptor 80, and engages with the pivot base 95. In examples, the pivot base 95 may be configured to receive and/or engage with at least a portion of the first pivot element 50. In examples, the pivot base 95 may be configured to apply a force on the first pivot element 50 during a shaving action. To this end, the pivot base 95 may be in the form of a groove configured to surround at least a portion of the first pivot element 50. In examples, the pivot base 95 is configured to surround at least an end (also may be referred to herein as a “tip”) 46 of the first pivot element 50. In this manner, the pivot base 95 is configured to pivot on and/or with respect to the first pivot element 50, to the extent allowed by flexure of the first pivot element 50 and, thus, flexure of the second pivot element 60.

In operation, as illustrated by FIGS. 2-4, when coupling the head 110 of the shaving device 100 to the handle 120 of the shaving device 100, the first pivot member 20 (i.e. the support 30 of the first pivot member 20, the first pivot element 50 of the first pivot member 20, and the second pivot element 60 of the first pivot member 20) is inserted into the second pivot member 70 (i.e. the adaptor 80 of the second pivot member 70). In this manner, the adaptor 80 and the support 30 engage each other, thereby forming a coupling between each other and, thus, between the head 110 and the handle 120. Additionally, during engagement of the adaptor 80 and the support 30, the first pivot element 50 engages the pivot base 95 of the second pivot member 70. During a shaving action performed by the user, movement of the head 110 along contours of the surface being shaved applies a force on the head 110, causing the head 110 to pivot with respect to the handle 120 and, thus, application of a force by the pivot base 95 on the first pivot element 50 and pivoting of the pivot base 95 with respect to the first pivot element 50. Application of a force by the pivot base 95 on the first pivot element 50 causes the first pivot element 50 to flex toward the second pivot element 60, decreasing the gap 44 between the first pivot element 50 and the second pivot element 60, such that the second pivot element 60 engages the first pivot element 50 at the central portion 42 of the first pivot element 50 to share a load distribution corresponding to the application of force on the first pivot element 50 by the pivot base 95.

In this manner, the first pivot member 20 and the second pivot member 70 of the pivot mechanism 10 are configured to control a pivot angle of the head 110 of the shaving device 100 with respect to the handle 120 of the shaving device 100, while improving durability of the pivot mechanism 10 and/or the shaving device 100 due to shared load distribution between the first pivot element 50 and the second pivot element 60. Additionally, in this manner, the pivot mechanism 10 employs a simplified configuration, including fewer components that are capable of being manufactured integrally in one piece, through inexpensive processes such as additive manufacturing and/or 3D printing.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A pivot mechanism configured for use on a shaving device, the pivot mechanism comprising:
a first pivot member including a support extending along an axis between a first end and a second end, a first pivot element, at least a portion of which extends axially from the first end of the support toward the second end of the support, and a second pivot element, at least a portion of which extends axially from the first end of the support toward the second end of the support;
a second pivot member configured to interact with the first pivot member, at least a portion of the second pivot member being configured to apply a force on the first pivot element and the second pivot element;
wherein the first pivot element and the second pivot element are configured to receive a force applied by the second pivot member and each of the first pivot element and the second pivot element are configured to flex in response to receiving a force applied by the second pivot member.

2. The pivot mechanism according to claim 1, wherein the first pivot element and the second pivot element are elastically deformable.

3. The pivot mechanism according to claim 1, wherein the first pivot element and the second pivot element are aligned with each other along the axis.

4. The pivot mechanism according to claim 1, wherein a gap is defined between at least a portion of the first pivot element and the second pivot element.

5. The pivot mechanism according to claim 1, wherein the first pivot element has a first length and the second pivot element has a second length, and the first length of the first pivot element is greater than the second length of the second pivot element.

6. The pivot mechanism according to claim 1, wherein the first pivot element extends to a position beyond the second end of the support.

7. The pivot mechanism according to claim 1, wherein the support defines a cavity extending between the first end and the second end of the support.

8. The pivot mechanism according to claim 7, wherein at least a portion of one or more of the first pivot element and the second pivot element extends within the cavity of the support.

9. The pivot mechanism according to claim 7, wherein the cavity of the support extends to an opening at the second end of the support.

10. The pivot mechanism according to claim 1, wherein the first pivot element includes an arcuate portion.

11. The pivot mechanism according to claim 10, wherein the arcuate portion of the first pivot element curves through a second plane corresponding to the second pivot element, to a position beyond the second plane corresponding to the second pivot element.

12. The pivot mechanism according to claim 1, wherein at least a portion of the first pivot element extends within a first plane along the axis, at least a portion of the second pivot element extends within a second plane along the axis, and at least a portion of the first pivot element extends toward the second plane corresponding to second pivot element.

13. The pivot mechanism according to claim 1, wherein the support, the first pivot element, and the second pivot element are integrally formed in one piece.

14. The pivot mechanism according to claim 1, wherein the first pivot element and the second pivot element are configured to return a force to the second pivot member, thereby sharing a load distribution corresponding to force exerted by the second pivot member between the first pivot element and the second pivot element and controlling a pivot angle of the head when a force is exerted on the first pivot element by the second pivot member.

15. The pivot mechanism according to claim 1, wherein the second pivot element extends to a position corresponding to a central portion of the first pivot element.

16. A shaving device comprising:
a shaving head configured to support one or more blade;
a handle configured to be held by a user; and
the pivot mechanism according to claim 1.

17. The shaving device according to claim 13, wherein the first pivot member of the pivot mechanism is included on the handle of the shaving device and the second pivot member of the pivot mechanism is included on the shaving head of the shaving device.

18. The shaving device according to claim 14, wherein the first pivot member of the pivot mechanism and the handle of the shaving device are integrally formed in one piece.
